(19) United States
(12) Patent Application Publication
(10) Pub. No.: US 2003/0223256 A1
(43) Pub. Date: Dec. 4, 2003

(54) AC-DC converters with integrated SVC

(76) Inventor: John J. Vithayathil, Portland, OR (US)

Correspondence Address: JOHN J. VITHAYATHIL, 6685 W. BURNSIDE, UNIT 355, PORTLAND, OR, 97210, US

(21) Appl. No.: 10/165,074

(22) Filed: Jun. 4, 2002

(51) Int. Cl. H02M 7/00

(52) U.S. Cl. 363/125

(57) ABSTRACT

The invention is for an ac-dc converter with an integrated SVC, which would provide independent control of the active and reactive power. In a three-phase bridge converter, the SVC is either connected to on the valve side of converter transformer or to the converter transformer itself. In the latter case, the SVC could be connected to a tertiary winding of the converter transformer, or one common transformer could function as the converter transformer and the SVC transformer. Any type of SVC, including the recently developed Voltage Controlled SVC could be used as the SVC for the three-phase bridge converter with integrated SVC. The ac-dc converter with integrated SVC could eliminate the need for on-load tap changers for the converter transformer. It could also reduce the size and losses in converter transformers. The SVC could also be modified to include harmonic filters for filtering harmonics from ac-dc conversion to get added savings in transformer size and losses.

### BACKGROUND

One of the advantages of Voltage Sourced Converters over conventional (current sourced or line commutated converters) is that they can almost independently control the power and reactive power of the converters. However, the voltage sourced converters are usually more expensive than conventional converters. Also, they have significantly higher losses. If the conventional converters also are provided with the capacity for independent control of power and reactive in a cost effective way, the performance and scope for application of conventional converters, especially for dc transmission, can be enhanced.

An ac-dc converter combined with a Static VAR Compensator (SVC) to control the reactive power should be able to provide independent control of active power and reactive power. Converter terminals normally have shunt connected reactive power elements for reactive power compensation and overvoltage control. One straight-forward method of introducing an SVC at the converter station would be to provide an SVC that incorporates some of these reactive power elements. Making use of the otherwise needed reactive components as part of an SVC would reduce the cost of providing an SVC at the converter terminal.

Such a combination of ac-dc converter and SVC connected to a relatively weak ac system should be able to raise the maximum power limits of the converter. The ability of the SVC to immediately compensate the reactive power demand changes in the converter would substantially alleviate the negative reaction of the weak ac system to those changes in reactive power demand of the converter which is the primary reason for the constraints on maximum power transfer. For such a combination of ac-dc converter working as an inverter and SVC, it is even possible to supply ac to an ac load which does not have any ac generation.

By integrating and optimally positioning such an SVC with the ac-dc converter, it is possible to derive additional benefits. These benefits include the elimination of on-load tap-changers for the transformer, reduction in the MVA rating of the converter transformers and reduction in converter transformer losses.

### BRIEF DESCRIPTION OF THE DRAWINGS

FIG. 1 shows a three-phase bridge converter with integrated SVC in which the SVC is positioned on the valve side of the converter transformer.

FIG. 2 shows a three-phase bridge converter with integrated SVC in which the SVC is connected to the tertiary winding of the converter transformer.

FIG. 3 shows schematic of a twelve pulse ac-dc converter with integrated SVC in which the SVC is connected to the tertiary winding of the converter transformer having a common primary winding for the delta and star connected valve side windings for the two six pulse converters forming the twelve pulse converter.

FIG. 4 shows schematic of a three-phase bridge converter with integrated SVC in which one transformer performs the function of the converter transformer and SVC transformer, taking the example of the Voltage Controlled Thyristor Switched Capacitor as the SVC.

FIG. 5 shows a combination of SVC and harmonic filters, taking the example of Voltage Controlled SVC.

### DETAILED DESCRIPTION OF THE INVENTION

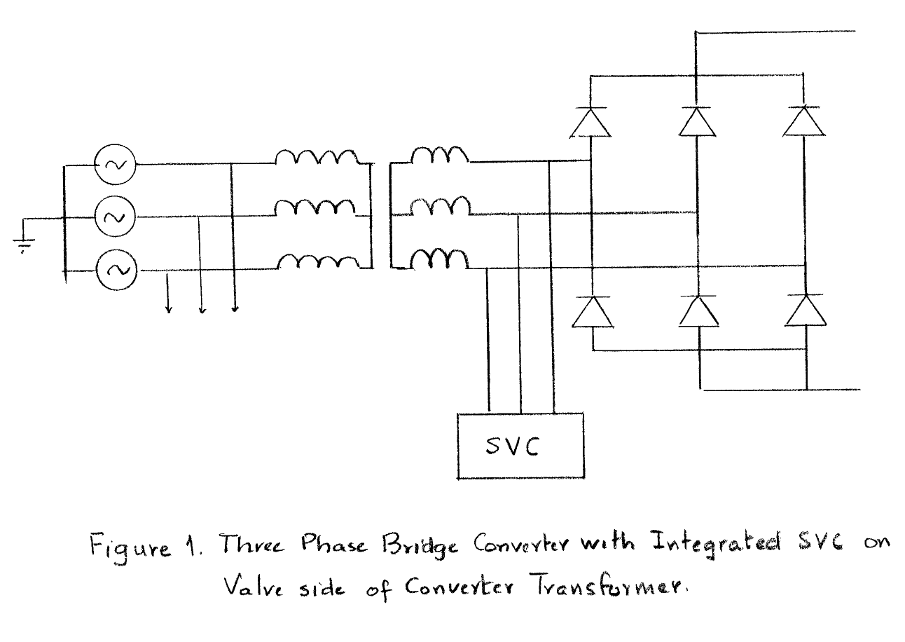

In the present invention two broadly different methods of positioning the SVC are proposed. In one case, the SVC is connected to the valve side terminal of the converter transformer (FIG. 1).

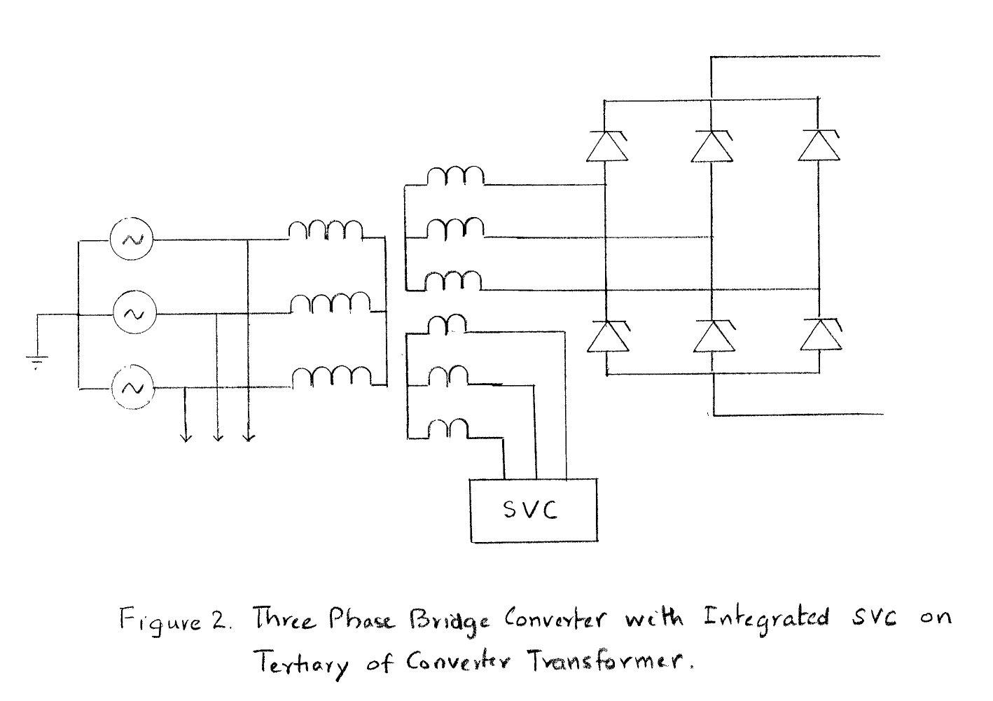

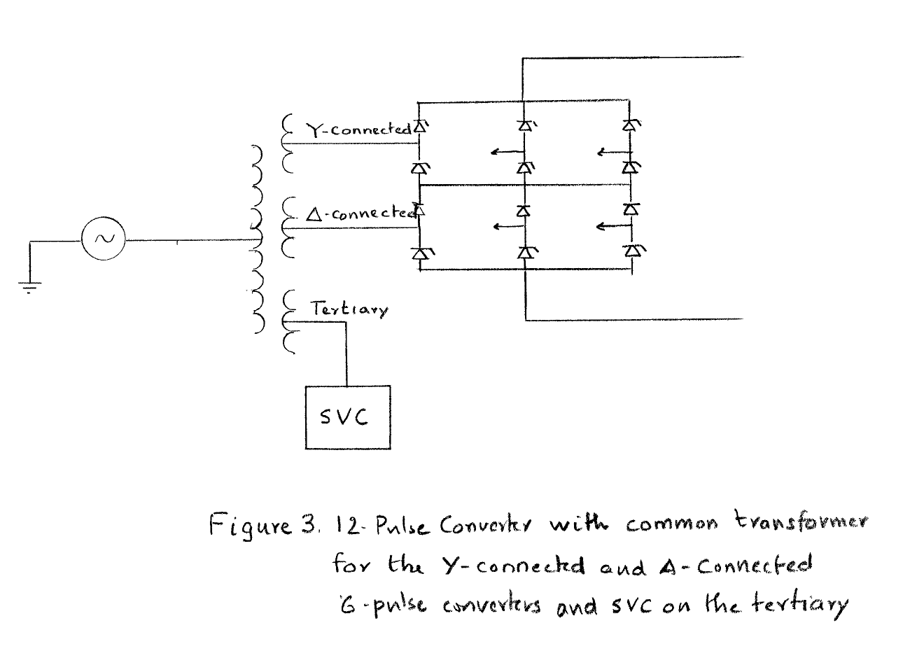

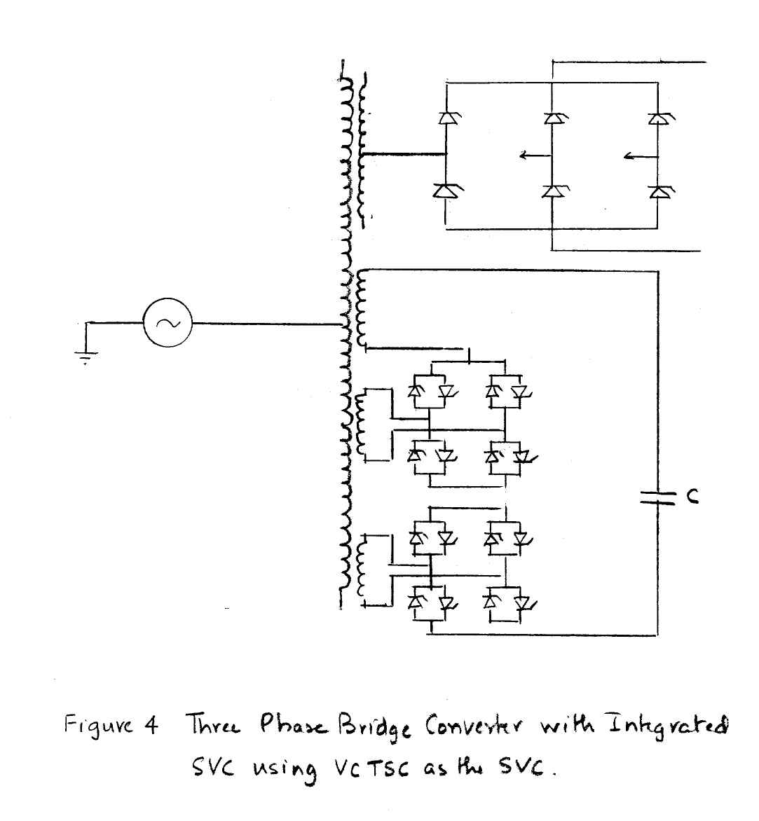

In the second case, the SVC is introduced through tertiary winding(s) in the converter transformer. There are two versions of the second case: In one version (FIGS. 2 and 3), a separate SVC transformer is connected to the tertiary of the converter transformer. An SVC so connected to the tertiary may or may not have separate SVC transformer. In the other version (FIG. 4), there is no separate SVC transformer, the primary winding of the converter transformer functions as the primary winding for the SVC, with secondary winding(s), separate from the valve winding, are connected to the back-to-back connected thyristors and the reactive elements of the SVC.

The SVC so integrated with the converter could be of any type—Thyristor Switched Capacitor (TSC), Thyristor Switched Reactor (TSR), Thyristor Controlled Reactor (TCR), Statcom or the recently developed Voltage Controlled SVC's.

The Voltage Controlled SVC is the subject of a pending patent application, No. 10141036.0, filed in Germany. A request for International Preliminary Examination for the same patent application was filed on Mar. 13, 2002.

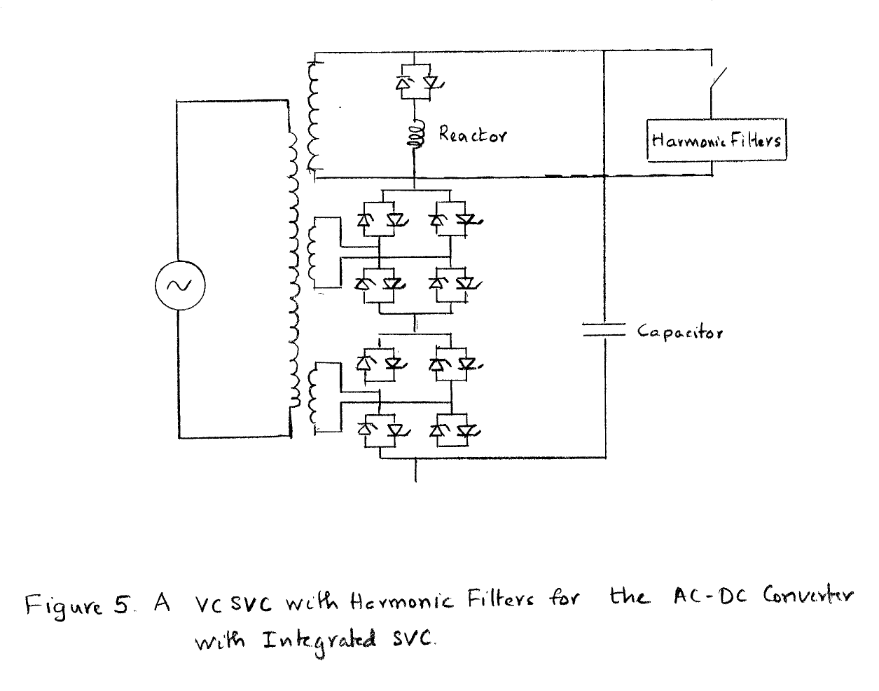

The Voltage Controlled SVC varies the reactive power through the SVC in steps by step changes in voltage applied to the reactive element, a capacitor or reactor, by static switching of transformer secondary windings. If the conditions do not require the provision of reactor in the SVC, the SVC would be a Voltage Controlled Thyristor Switched Capacitor (VCTSC). FIG. 4 shows the use of such an SVC for a three-phase bridge converter with integrated SVC. If the requirements call for providing a reactor only, a Voltage Controlled Thyristor Switched Reactor (VCTSR) could be used. In such a case FIG. 4 would have the capacitor, C, replaced by a reactor. If the conditions require changes in inductive and capacitive reactive power, Voltage Controlled SVC (VCSVC) with capacitor and reactor could be used. A particularly attractive arrangement is the one in which Thyristor Switched Reactor (TSR) is connected to the fixed winding. FIG. 5 shows such a circuit with the addition of harmonic filters also connected to the fixed winding as proposed for one version of the present invention described later.

Normally VCSVC provides for step changes in reactive power. By incorporating a small Thyristor Controlled Reactor in the VCSVC, it is possible to make the reactive power output of the SVC continuous by a combination of step and continuous changes of reactive power. The size of the TCR needs to be only small enough to provide the continuous variation of reactive power between the step changes. One can obtain the same result by providing a small control range for the Thyristor Switched Reactor in the VCSVC. Unless the rating of the controlled reactor is small enough that the harmonics due to its operation is negligible, such a controlled reactor would normally detract from one of the main advantages of VCSVC—the elimination of harmonic filters. However this may not be a significant consideration in the case of an SVC integrated with an ac-dc converter since harmonic filters are in any case needed for the ac-dc converter, and depending on the type of harmonic filters, it may be possible to take care of the harmonics due to the controlled reactor by the one harmonic filter filtering harmonics of both the ac-dc converter and the Thyristor Controlled Reactor.

The SVC of the present invention of converters with integrated SVC can be Voltage Controlled SVC's of any type including those with Thyristor Controlled Reactor for continuous control between discrete steps.

The SVC obviously provides the Converter with integrated SVC the ability to control independently active and reactive power. The position and integration of the SVC in this manner with the converter provide additional benefits in the form of reduction in converter transformer size, reduction in converter transformer losses and elimination of on-load tap changers for converter transformers.

Injecting or drawing reactive power by the SVC would alter the reactive power flowing through the inductive reactance of the converter transformer. Consequently the voltage at the point of connection of the SVC would rise or drop depending on the change in reactive power output of the SVC. That in turn will raise or lower the ac voltage applied to the converter valves. Thus the SVC in these positions can be used to carry out the function of the on-load tap changers used in such converters, particularly in dc transmission systems. The necessary voltage control to offset voltage changes at the ac terminals of the converter transformer or voltage variation due to changes in dc power or reactive power can be provided by the SVC.

Ac-dc converters normally consume significant amount of reactive power. For conventional ac-dc converters, typically, this reactive power demand is compensated by shunt capacitors on the ac side of the converter transformer. This would mean that the converter transformer has to be rated to carry both the active power and the reactive power. However, the SVC in the present invention can compensate the reactive power consumption of the converter on the valve side of the converter transformer or in the transformer itself. To the extent it reduces the reactive power flow through the converter transformer, the size of the transformer and the losses in the transformer could be reduced.

AC-DC converters generate harmonics which are typically filters by harmonic filters on the ac side of the converter transformer or on tertiary winding of the converter transformer. The provision and location of such harmonic filters do not limit the scope of the present invention.

SVC's could also have harmonic filters to filter harmonics generated by SVC's. In such cases the term SVC encompasses the harmonic filters provided for filtering the harmonics generated by the SVC.

A modification of the SVC which incorporates the harmonic filters for the ac-dc converters could also be used in converters with integrated SVC. For example, in the case of using the Voltage controlled SVC as the integrated SVC, the harmonic filters for the converter can be connected to a separate winding of the SVC transformer or, as shown in FIG. 5, to the fixed winding of the SVC transformer having the Thyristor Switched Reactor. The harmonic filters could be, but does not necessarily have to be, switched by static switches. Positioning the harmonic filters as part of the SVC in this manner could result in reduction in the flow of reactive power and harmonics through the converter transformers with consequent benefits of reduced transformer rating and losses.

In general, the invention is described in terms of three-phase bridge converter, which is a six pulse converter providing six pulse dc output. In dc transmission, it is common practice to have twelve pulse converters. To the extent a twelve pulse ac-dc converter comprises of two phase shifted six pulse converters, the description of the invention in terms of three phase bridge converter applies to the twelve pulse converter also. This is obvious when the two three phase bridge converters forming the twelve pulse converter have separate converter transformers. The invention is also applicable to twelve pulse converters formed by two three-phase bridge converters, with common converter transformer. An example of this is shown in FIG. 3.

The invention is equally applicable whether the converter transformers are single phase or three phase. The invention is applicable to the converter, whether it is operating as a rectifier or an inverter.

I claim:

1. A three phase bridge converter with integrated SVC comprising of a three phase bridge ac-dc converter and an SVC connected to the ac terminals of the converter valves.

2. The said SVC according to claim 1, modified to include harmonic filters to filter harmonics generated by ac-dc conversion.

3. A three phase bridge converter with integrated SVC comprising of a three phase bridge ac-dc converter and an SVC connected to a tertiary winding of the converter transformer.

4. The said SVC according to claim 3, modified to include harmonic filters to filter harmonics generated by ac-dc conversion.

5. A twelve-pulse bridge converter with integrated SVC comprising of one three phase bridge ac-dc converter with star-connected converter transformer windings on the valve side and another three phase bridge ac-dc converter with delta-connected converter transformer windings on the valve side, both star and delta connected windings in the same transformer, and an SVC connected to the tertiary windings on the converter transformer.

6. The said SVC according to claim 5, modified to include harmonic filters to filter harmonics generated by ac-dc conversion.

7. A three phase bridge converter with integrated SVC comprising of a three phase bridge ac-dc converter and an SVC with one common converter transformer for ac-dc converter and the SVC, with its primary winding connected to the ac system, a secondary winding connected to the converter valves and one or more additional windings to which parts of the SVC are connected.

8. The said SVC according to claim 7, modified to include harmonic filters to filter harmonics generated by ac-dc conversion

9. A twelve-pulse bridge converter with integrated SVC comprising of one three phase bridge ac-dc converter with star connected transformer windings on the valve side and another three phase bridge converter with delta connected converter transformer windings on the valve side, and an SVC which has its parts connected to one or more windings of the same common transformer for the two three phase bridge converters of the twelve pulse converter.

10. The said SVC according to claim 9, modified to include harmonic filters to filter harmonics generated by ac-dc conversion
